(19) United States
(12) Patent Application Publication
(10) Pub. No.: US 2024/0333394 A1
(43) Pub. Date: Oct. 3, 2024

(54) HIGH PRECISION PHOTONIC READOUT AND PERFORMING HIGH PRECISION PHOTON SENSING

(71) Applicant: Government of the United States of America, as represented by the Secretary of Commerce, Gaithersburg, MD (US)

(72) Inventors: Kevin O'Connell Douglass, Ellicott City, MD (US); Nikolai Nikolaevich Klimov, Gaithersburg, MD (US); Ashutosh Rao, Gaithersburg, MD (US)

(21) Appl. No.: 18/625,927

(22) Filed: Apr. 3, 2024

Related U.S. Application Data
(60) Provisional application No. 63/456,569, filed on Apr. 3, 2023.

(51) Int. Cl. H04B 10/556; H04B 10/079; H04B 10/50

(52) U.S. Cl. CPC H04B 10/5561; H04B 10/07955; H04B 10/504

(57) ABSTRACT

A high precision photonic readout for performing high precision photon sensing includes a laser source, photonic sensor, photonic sensor measurement module, laser and stabilization module. The photonic sensor measurement module receives the sensor light and produces a modulator control signal. The laser stabilization module receives the reference light and produces a phase lock signal that stabilizes the reference light frequency that controls the laser source to produce the reference light.

### CROSS REFERENCE TO RELATED APPLICATIONS

This application claims the benefit of U.S. Provisional Patent Application Ser. No. 63/456,569 (filed Apr. 3, 2023), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BRIEF DESCRIPTION

Disclosed is a high precision photonic readout 200 for performing high precision photon sensing, the high precision photonic readout 200 comprising: laser source 201 in electrical communication with laser stabilization module 211 and in optical communication with photonic sensor measurement module 212 and that receives phase lock signal 258 from laser stabilization module 211, produces reference light 203 with reference light frequency 204, communicates reference light 203 to laser stabilization module 211 and photonic sensor measurement module 212, such that reference light 203 comprises reference light frequency 204, is produced by laser source 201, is received by laser stabilization module 211 for production of phase lock signal 258, and is received by photonic sensor measurement module 212 for production of modulator control signal 252; and such that reference light frequency 204 produced by laser source 201 is stabilized by phase lock signal 258 from laser stabilization module 211; photonic sensor 202 disposed in photonic sensor measurement module 212 and in optical communication with laser source 201, electro optic phase modulator 218 and photonic sensor photodetector 260 and that receives offset light 247 with light offset frequency 248 from electro optic phase modulator 218, produces sensor light 249 with light offset frequency 248 from offset light 247, communicates sensor light 249 to photonic sensor photodetector 260; laser stabilization module 211 in optical communication with laser source 201 and that receives reference light 203 from laser source 201, and produces phase lock signal 258 that stabilizes reference light frequency 204 of reference light 203 from laser source 201; photonic sensor measurement module 212 in optical communication with laser source 201 and that receives reference light 203 from laser source 201, produces light offset frequency 248 from reference light 203 as a high precision photonic readout, and comprises electro optic phase modulator 218, photonic sensor 202, and photonic sensor photodetector 260; laser stabilization signal 245 that is produced by laser stabilization module 211 and communicated from laser stabilization module 211 to servo controller 227 for production of phase lock signal 258 that stabilizes reference light frequency 204 of reference light 203 produced by laser source 201; reference frequency 246 that is produced by RF mixer 228 of laser stabilization module 211 and is frequency of laser stabilization signal 245; modulator control signal 252 that is produced by reference frequency source 213 from frequency lock signal 251 and communicated by reference frequency source 213 to RF frequency counter 221 and electro optic phase modulator 218 for production of offset light 247 from reference light 203; and photonic sensor photodetector 260 disposed in photonic sensor measurement module 212 and in optical communication with photonic sensor 202 and in electrical communication with reference frequency source 213 and that receives sensor light 249 from photonic sensor 202, produces photodetector signal 250 from sensor light 249, communicates photodetector signal 250 to reference frequency source 213 for production of modulator control signal 252.

Disclosed is a process for performing high precision photon sensing with a high precision photonic readout 200, the process comprising: providing a photonic sensor 202 comprising a resonance frequency; providing reference light 203 comprising reference light frequency 204 that is offset from the resonance frequency of the photonic sensor 202; stabilizing reference light frequency 204 to optical reference cavity 209 via locking reference light frequency 204 to an optical mode of optical reference cavity 209; modulating reference light 203 with reference frequency 251 that is substantially equal to or greater than the resonance frequency 257 of the photonic sensor 202; modulating reference light 203 with a broadband EOM phase-modulator 218 with modulator control signal 252; detecting the sensor light 249 that is reflected from or transmitted through photonic sensor 202; measuring light offset frequency 248 of sensor light 249; and determining the temperature or strain of the photonic sensor 202 from the modulator control signal 252.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a high precision photonic readout 200.

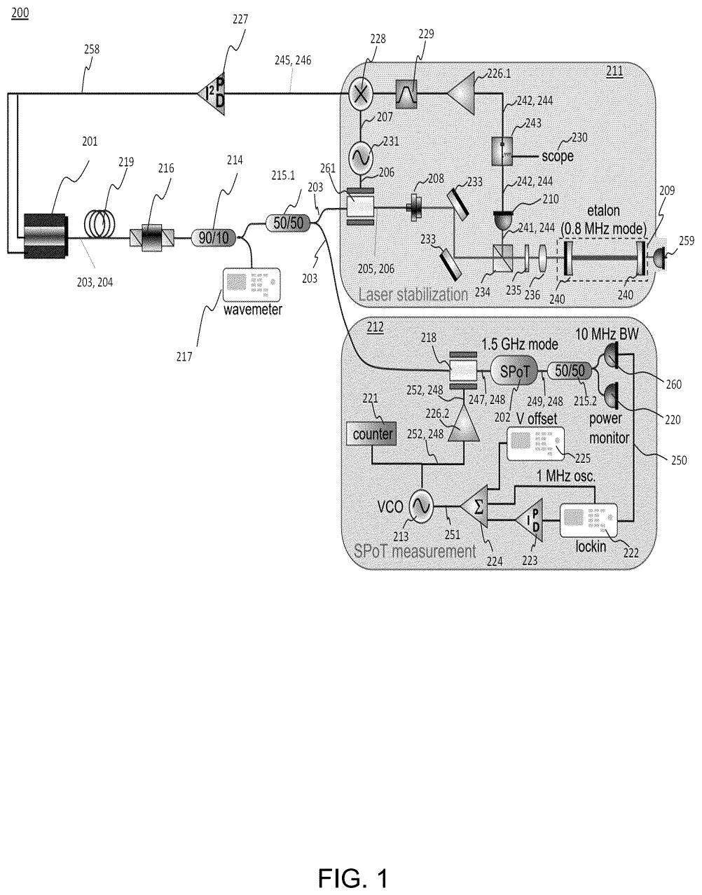

FIG. 2 shows, according to some embodiments, a high precision photonic readout 200.

FIG. 3 shows, according to some embodiments, data acquired for a high precision photonic readout 200.

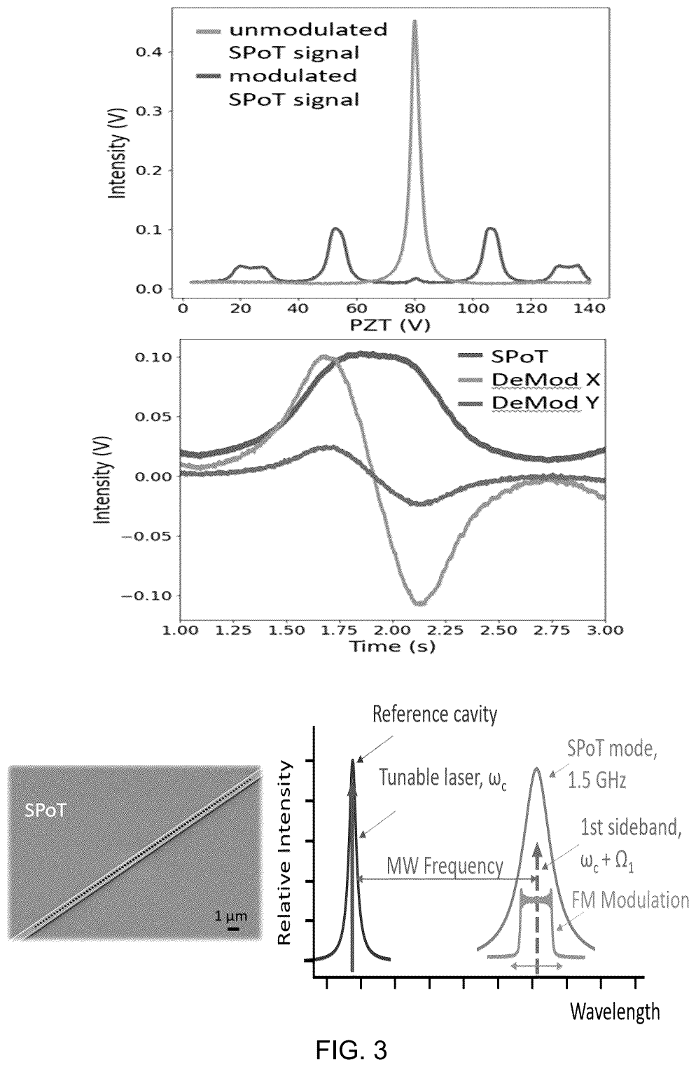

FIG. 4 shows, according to some embodiments, a Pound-Hall-Drever sideband lock for a high precision photonic readout 200.

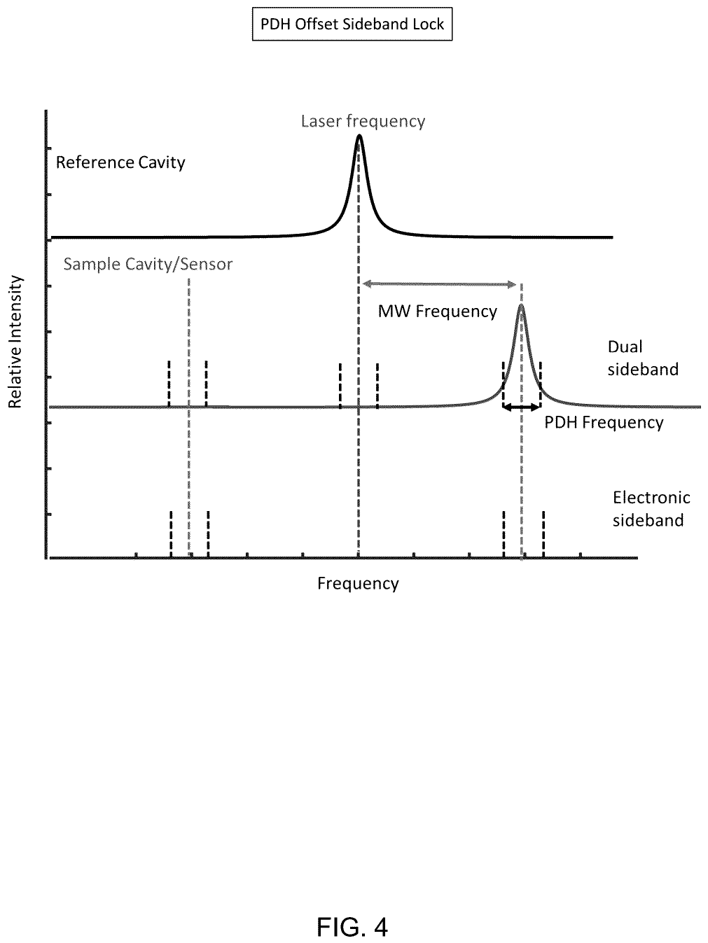

FIG. 5 shows, according to some embodiments, sideband error signal for a high precision photonic readout 200.

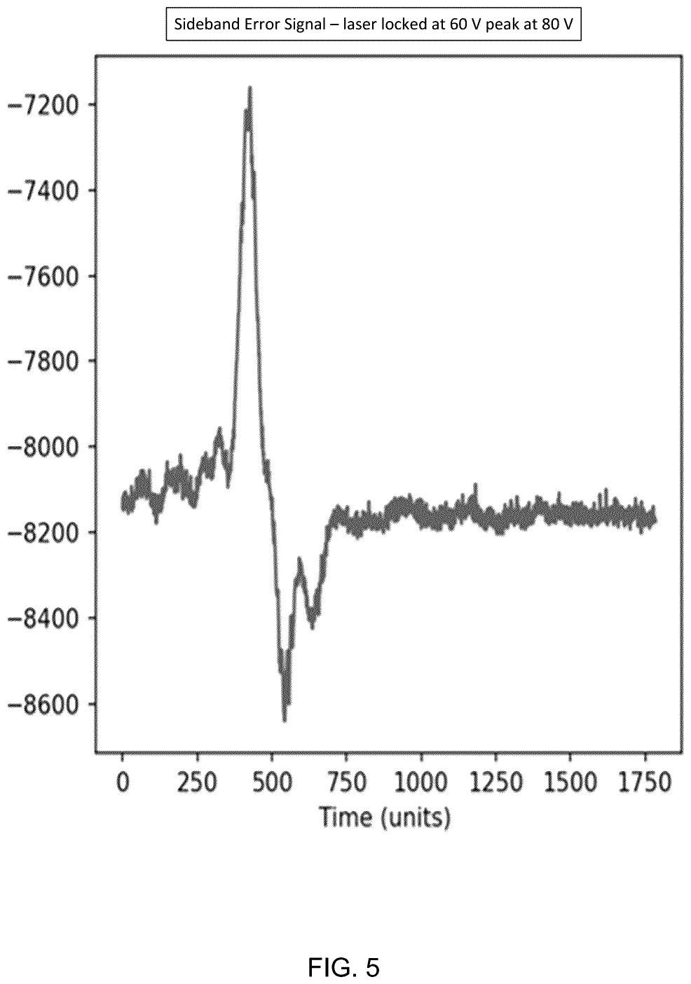

FIG. 6 shows, according to some embodiments, an electronic sideband with dither lock for a high precision photonic readout 200.

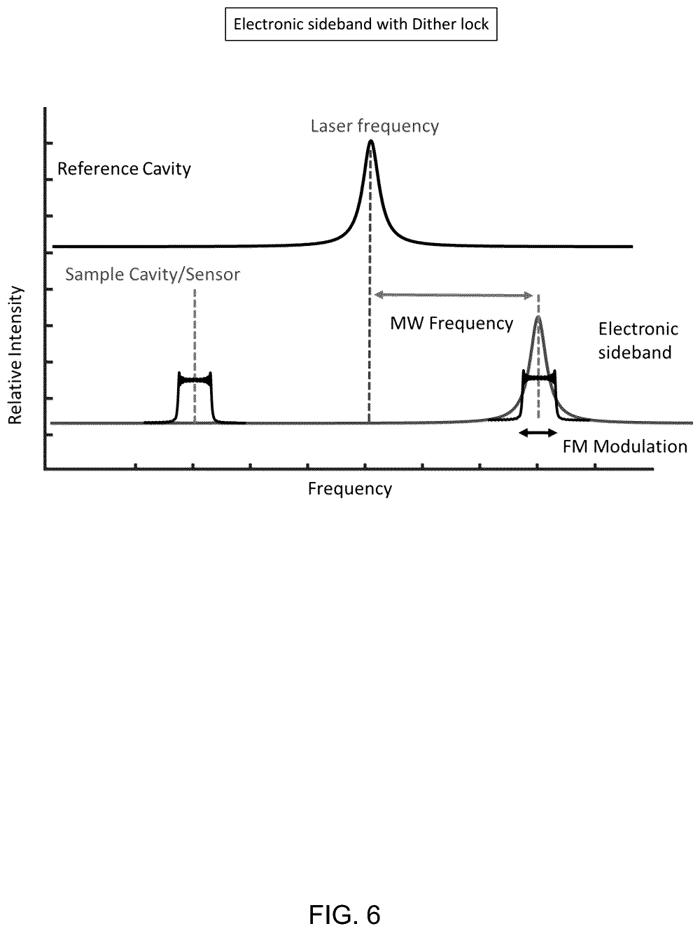

FIG. 7 shows, according to some embodiments, photon sensor signal with error signals for a high precision photonic readout 200.

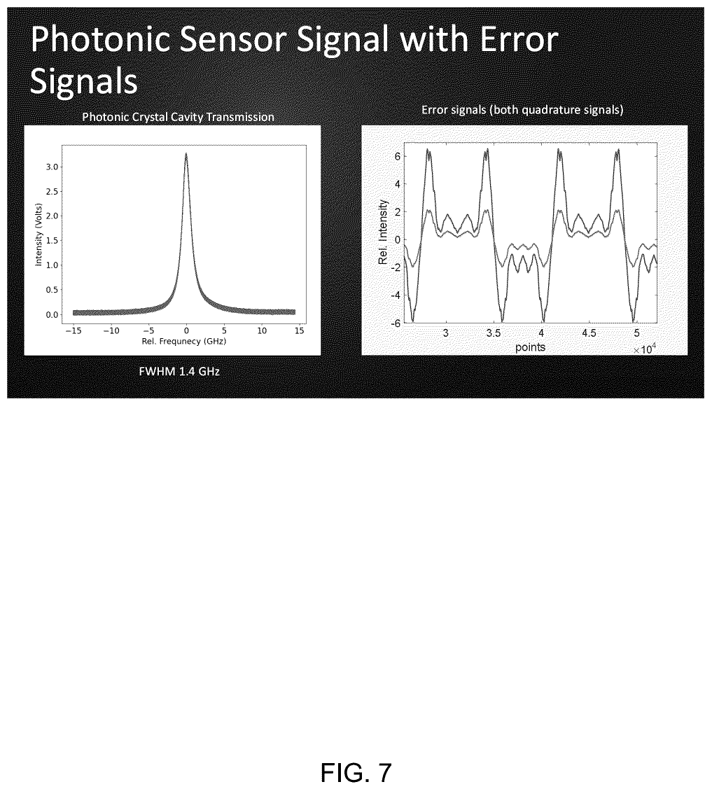

FIG. 8 shows, according to some embodiments, a photonic sensor resonance for a high precision photonic readout 200.

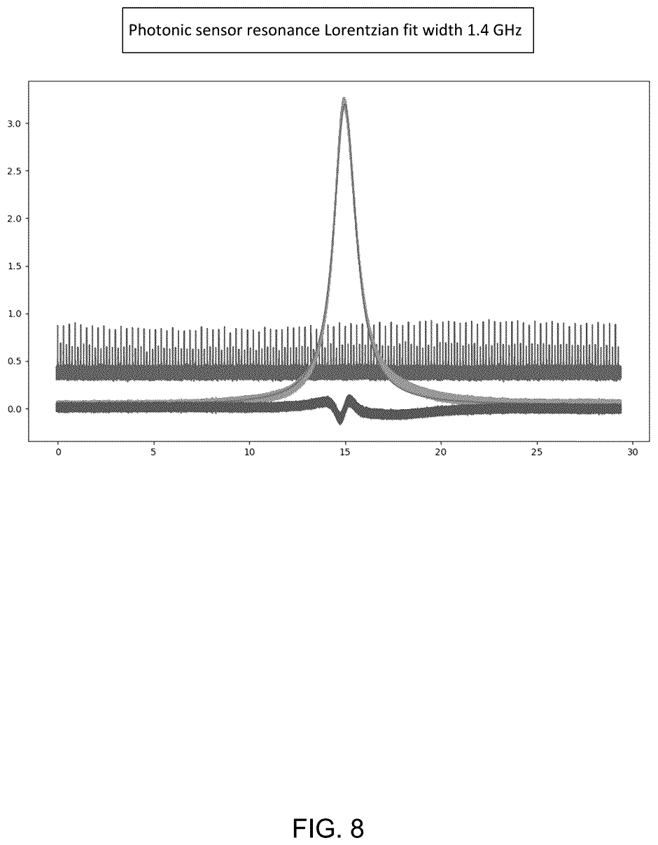

FIG. 9 shows, according to some embodiments, Allan deviation for a high precision photonic readout 200.

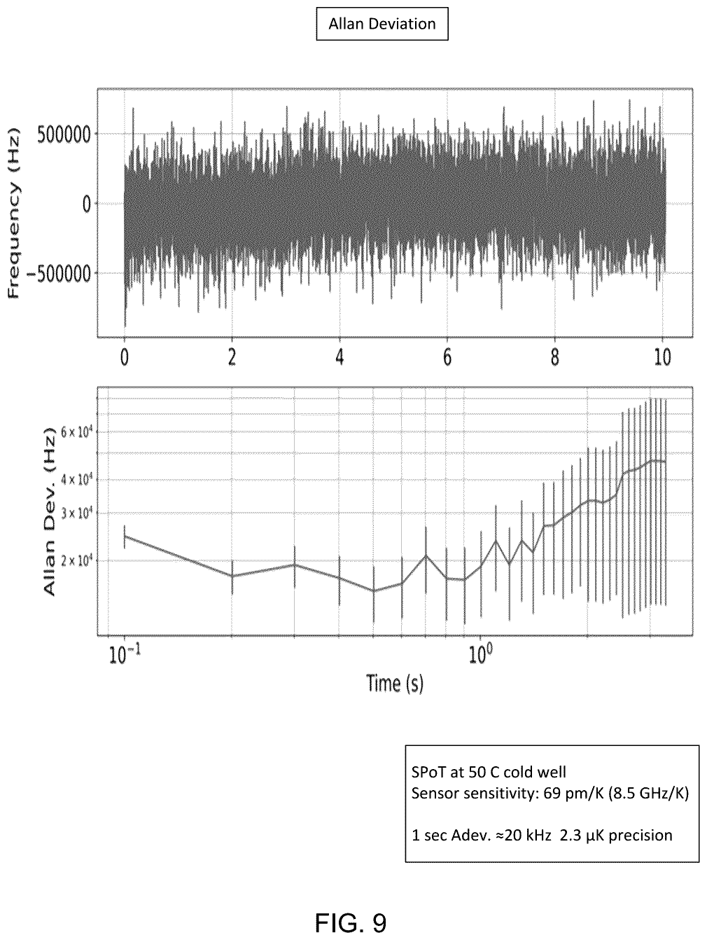

### DETAILED DESCRIPTION

A detailed description of one or more embodiments is presented herein by way of exemplification and not limitation.

Photonic sensors are a promising technology for a variety of applications, including temperature sensing, strain sensing, stress sensing, humidity sensing, moisture sensing, and chemical sensing. However, the precision of photonic sensors is often limited by the difficulty of accurately measuring the optical frequency of the sensor's resonance. Conventional methods for measuring the optical frequency of a photonic sensor typically involve wavelength meter to track the sensor's resonance. However, this method is susceptible to noise drift, and slow speed which can limit the precision of the measurement.

Photonic sensors are a rapidly growing field with applications in a wide range of industries, including telecommunications, healthcare, and manufacturing. One of the key challenges in photonic sensing is the accurate measurement of the resonance frequency of a photonic sensor. This is typically done by using a phase-locked loop (PLL) to lock the frequency of a laser to the resonance frequency of the sensor. However, PLLs can be susceptible to noise and drift, which can lead to errors in the measurement of the resonance frequency.

Moreover, a challenge in photonic sensing is the accurate measurement of the resonance frequency of the sensor. This is typically done by using a technique called heterodyne detection, in which the light from the sensor is mixed with a light from a reference laser. The offset frequency of the reference laser is then adjusted until the beat frequency between the two laser lights is at detectable bandwidth range. This minimum beat frequency corresponds to the resonance frequency of the sensor. However, heterodyne detection can be challenging to implement, particularly for high precision measurements. This is because the reference laser must be very stable, and the beat frequency must be accurately measured. Additionally, heterodyne detection can be susceptible to noise, which can degrade the accuracy of the measurement.

Another challenge in photonic sensing is the need for a high-speed detector. This is because the full width half maximum linewidth of the resonance frequencies of photonic sensors are typically in the GHz range. To perform a Pound-Drever-Hall (PDH) type lock requires bandwidth of hundreds of MHz to GHz, which requires high speed detectors. However, high-speed detectors can be expensive and suffer from low noise.

The present invention provides a method and apparatus for high precision photonic readout that overcomes the challenges described above.

The methods herein greatly improves the precision of photonic readout for the standard photonic thermometer (SPOT), for measuring temperature based on opto-refractivity changes or other frequency dependent changes such as strain. This method uses a single laser locked to a stable high-finesse optical cavity and/or frequency comb then offset locked to a photonic sensor for direct optical frequency readout. Furthermore, our approach can be readily applied to a wide variety of photonics-based sensors that require high-resolution and accurate measurement of sensor's resonance optical frequency. Our approach can also include a photonic sensor network readout using a single laser system.

The methodology of offset sideband locking is applied to the NIST the standard photonic thermometer (SPOT) (the description of which is included in U.S. Pat. No. 10,955,617), which is incorporated by reference in its entirety, in which the single laser operating at telecom wavelength is split, half of the power is used to stabilize the laser to the reference cavity and the other half is coupled to a broad bandwidth low VIT electo-optic phase modulator (EOM) which is separately locked to the photonic sensor. Alternatively, the laser can be phase-locked to a frequency comb and offset locked to the sensor in a similar manner. The EOM on the photonic sensor is driven by an RF source or modulated FM source on the order of a gigahertz. Dual-side band Pound-Drever-Hall (PDH) and electronic side-band methods were tested, following the methodology set out by Thorpe et al. Our novel electronic sideband dither lock approach was also tested with great success. This approach improves the speed of the measurement and accuracy by 3 and 1 orders of magnitude, respectively. Since such small infrared power is required to prevent self-heating a low bandwidth detector with very high sensitivity and low noise must be used in the setup. The PDH method requires a very high bandwidth detector because the width of the photonic sensor resonant mode is relatively large (>GHz). In contrast, the dither approach involves a moderate bandwidth detector (MHz). The other advantage of our approach is that it can include only a single laser for the measurement and thus eliminates a second laser and high speed detector. Our approach can include a counter. Furthermore, our approach can include a photonic sensor network with a single laser that can be used to measure all sensors in the network.

In an embodiment, high precision photonic readout 200 for performing high precision photon sensing includes: a photonic sensor having a resonance frequency; a laser having a frequency that is offset from the resonance frequency of the photonic sensor; a modulator for modulating the laser with a frequency that is substantially equal to the resonance frequency of the photonic sensor; a detector for detecting the light that is reflected from or transmitted through the photonic sensor; a frequency counter for measuring the offset frequency of the light that is driving the EOM in resonance with the photonic sensor; and a controller for using the measured frequency to determine the temperature, strain, or other property of the photonic sensor.

In an embodiment, high precision photonic readout 200 includes: a laser source (201) in electrical communication with a laser stabilization module (211) and in optical communication with a photonic sensor measurement module (212) and that receives a phase lock signal (258) from the laser stabilization module (211), produces reference light (203) with a reference light frequency (204), communicates reference light (203) to the laser stabilization module (211) and the photonic sensor measurement module (212); a photonic sensor (202) disposed in the photonic sensor measurement module (212) and in optical communication with the laser source (201) and in optical communication with an electro optic phase modulator (218) and in optical communication with a photonic sensor photodetector (260) and that receives offset light (247) with a light offset frequency (248) from the electro optic phase modulator (218), produces sensor light (249) with a light offset frequency (248) from offset light (247), communicates sensor light (249) to the photonic sensor photodetector (260); reference light (203) that comprises a reference light frequency (204), is produced by the laser source (201), is received by the laser stabilization module (211) for production of the phase lock signal (258), and is received by the photonic sensor measurement module (212) for production of a modulator control signal (252); reference light frequency (204) that is produced by the laser source (201) and stabilized by the phase lock signal (258) from the laser stabilization module (211); a laser stabilization module (211) in optical communication with the laser source (201) and that receives reference light (203) from the laser source (201), and produces the phase lock signal (258) that stabilizes the reference light frequency (204) of reference light (203) from the laser source (201); a photonic sensor measurement module (212) in optical communication with the laser source (201) and that receives reference light (203) from the laser source (201), produces a light offset frequency (248) from reference light (203) as a high precision photonic readout, and comprises the electro optic phase modulator (218), the photonic sensor (202), and the photonic sensor photodetector (260); a laser stabilization signal (245) that is produced by the laser stabilization signal (245) and communicated from the laser stabilization module (211) to a servo controller (227) for production of the phase lock signal (258) that stabilizes the reference light frequency (204) of reference light (203) produced by the laser source (201); a reference frequency (246) that is produced by an RF mixer (228) of the laser stabilization module (211) and is the frequency of the laser stabilization signal (245); a modulator control signal (252) that is produced by a reference frequency source (213) from a frequency lock signal (251) and communicated by the reference frequency source (213) to an RF frequency counter (221) and the electro optic phase modulator (218) for production of offset light (247) from reference light (203); and a photonic sensor photodetector (260) disposed in the photonic sensor measurement module (212) and in optical communication with the photonic sensor (202) and in electrical communication with the reference frequency source (213) and that receives sensor light (249) from the photonic sensor (202), produces a photodetector signal (250) from offset light (247), communicates the photodetector signal (250) to the reference frequency source (213) for production of the modulator control signal (252).

In an embodiment, high precision photonic readout 200 includes: electro optic phase modulator 218 disposed in photonic sensor measurement module 212 and in optical communication with laser source 201 and in optical communication with photonic sensor 202 and in electrical communication with reference frequency source 213 and that receives reference light 203 from laser source 201, receives modulator control signal 252 with light offset frequency 248 from reference frequency source 213, produces offset light 247 with light offset frequency 248 by modulating reference light 203 with modulator control signal 252, and communicates offset light 247 to photonic sensor 202 for production of modulator control signal 252 by photonic sensor measurement module 212; and RF frequency counter 221 disposed in photonic sensor measurement module 212 and in electrical communication with reference frequency source 213 and that receives modulator control signal 252 with light offset frequency 248 from reference frequency source 213 in response to reference frequency source 213 receiving frequency lock signal 251 and determines light offset frequency 248.

In an embodiment, high precision photonic readout 200 includes fiber-to-free space coupler 208 in optical communication with electro optic phase modulator 218 and in optical communication with optical reference cavity 209 and that receives modulated light 205 with modulation frequency 206 from electro optic phase modulator 218 of laser stabilization module 211 and communicates modulated light 205 to optical reference cavity 209 for production of reflected reference light 241 by optical reference cavity 209. Fiber-to-free space coupler 208 is in optical communication with electro optic phase modulator 218 and in optical communication with optical reference cavity 209. fiber-to-free space coupler 208 and receives modulated light 205 with modulation frequency 206 from electro optic phase modulator 218 of laser stabilization module 211 and communicates modulated light 205 to optical reference cavity 209 for production of reflected reference light 241 by optical reference cavity 209.

In an embodiment, high precision photonic readout 200 includes: reference frequency source 213 disposed in photonic sensor measurement module 212 and in electrical communication with electro optic phase modulator 218 and in electrical communication with photonic sensor photodetector 260 and that receives frequency lock signal 251 as a result of production of photodetector signal 250 by photonic sensor photodetector 260 of photonic sensor measurement module 212, produces modulator control signal 252 with light offset frequency 248 from frequency lock signal 251, and communicates modulator control signal 252 to electro optic phase modulator 218 of photonic sensor measurement module 212 for production of offset light 247 from reference light 203; and reference frequency source 213 is disposed in photonic sensor measurement module 212 and in electrical communication with electro optic phase modulator 218 and in electrical communication with photonic sensor photodetector 260. Reference frequency source 213 receives frequency lock signal 251 as a result of production of photodetector signal 250 by photonic sensor photodetector 260 of photonic sensor measurement module 212. Reference frequency source 213 produces modulator control signal 252 with light offset frequency 248 from frequency lock signal 251. reference frequency source 213 communicates modulator control signal 252 to electro optic phase modulator 218 of photonic sensor measurement module 212 for production of offset light 247 from reference light 203.

In an embodiment, high precision photonic readout 200 includes: optical power splitter 214 in optical communication with laser source 201 and in optical communication with laser stabilization module 211 that receives reference light 203 from laser source 201, optically splits reference light 203, and communicates reference light 203 to laser stabilization module 211 and wavelength meter 217; optical power splitter 215 in optical communication with laser source 201 and in optical communication with laser stabilization module 211 and in optical communication with photonic sensor measurement module 212 and that receives reference light 203 from laser source 201, optically splits reference light 203, and communicates reference light 203 to laser stabilization module 211 and photonic sensor measurement module 212; and optical isolator 216 in optical communication with laser source 201 and in optical communication with laser stabilization module 211 and in optical communication with photonic sensor measurement module 212 and that receives reference light 203 from laser source 201, communicates reference light 203 to laser stabilization module 211 and photonic sensor measurement module 212, and optically isolates light from laser stabilization module 211 and photonic sensor measurement module 212 from transmission to laser source 201.

In an embodiment, high precision photonic readout 200 includes: high precision photonic readout 200 of claim 1, further comprising optical fiber 219 in optical communication with laser source 201 and in optical communication with laser stabilization module 211 and in optical communication with photonic sensor measurement module 212 and that receives reference light 203 from laser source 201 and communicates reference light 203 to laser stabilization module 211 and photonic sensor measurement module 212.

In an embodiment, high precision photonic readout 200 includes: wavelength meter 217 in optical communication with laser source 201 and that receives reference light 203 from laser source 201 and determines an optical wavelength of reference light 203; and optical power meter 220 disposed in photonic sensor measurement module 212 and in optical communication with photonic sensor 202 and that receives sensor light 249 with light offset frequency 248 from photonic sensor 202 in response to photonic sensor 202 receiving offset light 247 with light offset frequency 248 from electro optic phase modulator 218 and determines an optical power of sensor light 249.

In an embodiment, high precision photonic readout 200 includes lock-in amplifier 222 disposed in photonic sensor measurement module 212 and in electrical communication with photonic sensor photodetector 260 and in electrical communication with reference frequency source 213 and that receives photodetector signal 250 from photonic sensor photodetector 260 and provides frequency lock signal 251 to reference frequency source 213 for production of modulator control signal 252.

In an embodiment, high precision photonic readout 200 includes: servo controller 223 disposed in photonic sensor measurement module 212 and in electrical communication with lock-in amplifier 222 and in electrical communication with reference frequency source 213 and that receives output from lock-in amplifier 222 and sends frequency lock signal 251 to reference frequency source 213 from which modulator control signal 252 is produced; summing amplifier 224 disposed in photonic sensor measurement module 212 and in electrical communication with servo controller 223 and in electrical communication with DC voltage source 225 and in electrical communication with lock-in amplifier 222 and in electrical communication with reference frequency source 213 and that receives output from servo controller 223, lock-in amplifier 222, DC voltage source 225, produces frequency lock signal 251 from outputs of servo controller 223, lock-in amplifier 222, and DC voltage source 225, and communicates frequency lock signal 251 to reference frequency source 213 for production of modulator control signal 252; DC voltage source 225 disposed in photonic sensor measurement module 212 and in electrical communication with summing amplifier 224 and that produces a DC voltage that summing amplifier 224 sums with outputs from lock-in amplifier 222 and servo controller 223 in production of frequency lock signal 251; and frequency lock signal 251 that is produced from photodetector signal 250 by lock-in amplifier 222 and received by reference frequency source 213 for production of modulator control signal 252.

In an embodiment, high precision photonic readout 200 includes: servo controller 223 disposed in photonic sensor measurement module 212 and in electrical communication with lock-in amplifier 222 and in electrical communication with reference frequency source 213 and that receives output from lock-in amplifier 222 and sends frequency lock signal 251 to reference frequency source 213 from which modulator control signal 252 is produced; summing amplifier 224 disposed in photonic sensor measurement module 212 and in electrical communication with servo controller 223 and in electrical communication with DC voltage source 225 and in electrical communication with lock-in amplifier 222 and in electrical communication with reference frequency source 213 and that receives output from servo controller 223, lock-in amplifier 222, DC voltage source 225, produces frequency lock signal 251 from outputs of servo controller 223, lock-in amplifier 222, and DC voltage source 225, and communicates frequency lock signal 251 to reference frequency source 213 for production of modulator control signal 252; DC voltage source 225 disposed in photonic sensor measurement module 212 and in electrical communication with summing amplifier 224 and that produces a DC voltage that summing amplifier 224 sums with outputs from lock-in amplifier 222 and servo controller 223 in production of frequency lock signal 251; and frequency lock signal 251 that is produced from photodetector signal 250 by lock-in amplifier 222 and received by reference frequency source 213 for production of modulator control signal 252.

In an embodiment, high precision photonic readout 200 includes: RF mixer 228 disposed in laser stabilization module 211 and in electrical communication with photodetector 210 and in electrical communication with servo controller 227, receiving reference stabilization signal 242 from photodetector 210, producing laser stabilization signal 245 with reference frequency 246 from reference stabilization signal 242, and communicating laser stabilization signal 245 to servo controller 227; RF filter 229 disposed in laser stabilization module 211 and in electrical communication with RF mixer 228 and in electrical communication with photodetector 210, receiving reference stabilization signal 242 from photodetector 210, filtering the RF component of reference stabilization signal 242, and communicating the RF component to RF mixer 228; and optical stabilization radio frequency component 244 that is produced by photodetector 210 from receipt of reflected reference light 241 from optical reference cavity 209 and received by RF filter 229 for production of laser stabilization signal 245 by RF mixer 228.

In an embodiment, high precision photonic readout 200 includes oscilloscope 230 disposed in laser stabilization module 211 and in electrical communication with photodetector 210 and that receives reference stabilization signal 242 from photodetector 210 and processes reference stabilization signal 242.

In an embodiment, high precision photonic readout 200 includes oscillator 231 disposed in laser stabilization module 211 and in electrical communication with photodetector 210 and in electrical communication with electro optic phase modulator 218, that receives modulation control signal 207 from RF mixer 228, produces modulation frequency 206 from modulation frequency 206, and communicates reference light 203 to electro optic phase modulator 218 for modulation of reference light 203.

In an embodiment, high precision photonic readout 200 includes planar optical mirror 233 disposed in laser stabilization module 211 and in optical communication with electro optic phase modulator 218 and in optical communication with optical reference cavity 209 and that receives modulated light 205 from electro optic phase modulator 218, directs propagation of modulated light 205 in laser stabilization module 211, and communicates modulated light 205 to optical reference cavity 209.

In an embodiment, high precision photonic readout 200 includes: polarizing beam splitter 234 disposed in laser stabilization module 211 and in optical communication with electro optic phase modulator 218 and in optical communication with optical reference cavity 209 and that receives modulated light 205 from electro optic phase modulator 218, communicates modulated light 205 from electro optic phase modulator 218 to optical reference cavity 209, receives reflected reference light 241 from optical reference cavity 209, and communicates reflected reference light 241 from optical reference cavity 209 to photodetector 210; polarizer 235 disposed in laser stabilization module 211 and in optical communication with polarizing beam splitter 234 and in optical communication with optical reference cavity 209 and that receives modulated light 205 from polarizing beam splitter 234, communicates modulated light 205 from polarizing beam splitter 234 to optical reference cavity 209, receives reflected reference light 241 from optical reference cavity 209, and communicates reflected reference light 241 from optical reference cavity 209 to polarizing beam splitter 234; and lens 236 disposed in laser stabilization module 211 and in optical communication with polarizing beam splitter 234 and in optical communication with optical reference cavity 209 and that receives modulated light 205 from polarizing beam splitter 234, communicates modulated light 205 from polarizing beam splitter 234 to optical reference cavity 209, receives reflected reference light 241 from optical reference cavity 209, and communicates reflected reference light 241 from optical reference cavity 209 to polarizing beam splitter 234.

In an embodiment, high precision photonic readout 200 includes optical frequency comb 238 that comprises a plurality of optical comb tooth 255, is produced by laser stabilization module 211 and is received by optical filter 254 in laser stabilization module 211.

In an embodiment, high precision photonic readout 200 includes high precision photonic readout 200 of claim 2, further comprising cavity mirror 240 disposed in laser stabilization module 211 and in optical communication with electro optic phase modulator 218 and in optical communication with photodetector 210, comprising a cavity mode with a resonance at optical stabilization radio frequency component 244, receiving modulated light 205 from electro optic phase modulator 218, producing reflected reference light 241 with optical stabilization radio frequency component 244 from modulated light 205, and communicating reflected reference light 241 to photodetector 210.

In an embodiment, high precision photonic readout 200 includes bias tee 243 disposed in laser stabilization module 211 and in electrical communication with photodetector 210 and in electrical communication with oscilloscope 230 and in electrical communication with RF mixer 228 and that receives reference stabilization signal 242 from photodetector 210, and communicates reference stabilization signal 242 to oscilloscope 230 and RF filter 229 for production of laser stabilization signal 245 by RF mixer 228.

In an embodiment, high precision photonic readout 200 includes photodetector signal 250 that is produced by photonic sensor photodetector 260 from sensor light 249 and received by lock-in amplifier 222 for production of modulator control signal 252 in photonic sensor measurement module 212.

In an embodiment, high precision photonic readout 200 includes: optical filter 254 disposed in laser stabilization module 211 and in electrical communication with fiber coupler 256, receiving optical frequency comb 238, selecting optical comb tooth 255 from optical comb tooth 255, and communicating optical comb tooth 255 to fiber coupler 256 for combination with reference light 203; optical comb tooth 255 that is an optical component of optical frequency comb 238 that is optically selected by optical filter 254 and combined with reference light 203 to produce comb-reference combined light 257 from which laser stabilization signal 245 is produced; and comb-reference combined light 257 that is produced by fiber coupler 256 from combining reference light 203 and optical comb tooth 255.

In an embodiment, high precision photonic readout 200 includes: fiber coupler 256 disposed in laser stabilization module 211 and in optical communication with laser source 201 and in optical communication with optical filter 254 and that receives optical comb tooth 255 from optical filter 254, receives reference light 203 from laser source 201, produces comb-reference combined light 257 from optically combining reference light 203 and optical comb tooth 255, and communicates comb-reference combined light 257 to photodetector 210 for production of laser stabilization signal 245; and transmission photodetector 259 disposed in laser stabilization module 211 and in optical communication with optical reference cavity 209 and that receives modulated light 205 transmitted through optical reference cavity 209.

High precision photonic readout 200 can include laser source 201, optical isolator 216, optical power splitter 214, wavelength meter 217, optical power splitter 215, wherein reference light 203 enters laser stabilization module 211 that includes electro optic phase modulator 261 that is driven by oscillator 231, fiber-to-free space coupler 208, planar optical mirror 233, polarizing beam splitter 234, polarizer 235 (e.g., a quarter wave plate), lens 236 (e.g., a mode matching lens). Modulated light 205 is directed into optical reference cavity 209 with cavity mirror 240. Transmission through optical reference cavity 209 can be detected with transmission photodetector 259. Reflected reference light 241 from optical reference cavity 209 is detected by photodetector 210. Reflected reference light 241 is used to produce reference stabilization signal 242 by photodetector 210 and is sent through bias tee 243 for observing reference stabilization signal 242 and optical stabilization radio frequency component 244 on oscilloscope 230 are that are amplified by first RF amplifier 226.1, filtered by RF filter 229, and demodulated by RF mixer 228 using modulation control signal 207 from oscillator 231 to produce laser stabilization signal 245 with reference frequency 246. Laser stabilization signal 245 is an error signal that is received by servo controller 227 (e.g., a PI²D controller) that produces phase lock signal 258 from laser stabilization signal 245. Phase lock signal 258 is received by laser source 201 for stabilizing reference light frequency 204 on optical reference cavity 209. Reference light 203 is communicated froom optical power splitter 215 to photonic sensor measurement module 212. Reference light 203 is received by electro optic phase modulator 218 (or an acusto-optic modulator not shown) that produces offset light 247 with light offset frequency 248. Offset light 247 is received by photonic sensor 202 that produces sensor light 249 that is received by photonic sensor photodetector 260 and optical power meter 220. The input power to photonic sensor 202 is also set carefully and recorded. Photodetector signal 250 from photonic sensor photodetector 260 is received by lock-in amplifier 222 for digitical demodulation and servo controller 223 (e.g., a PID controller). Frequency lock signal 251 is received by reference frequency source 213 (e.g., a voltage controlled oscillator or other frequency source) that produces modulator control signal 252 with light offset frequency 248 that is measured by RF frequency counter 221 and received by second RF amplifier 226.2 that drives electro optic phase modulator 218. Photonic sensor measurement module 212 makes light offset frequency 248 from reference light 203 and locks light offset frequency 248 onto photonic sensor 202. Light offset frequency 248 is read from RF frequency counter 221 and is added or subtracted from reference light 203 with known absolute wavelength.

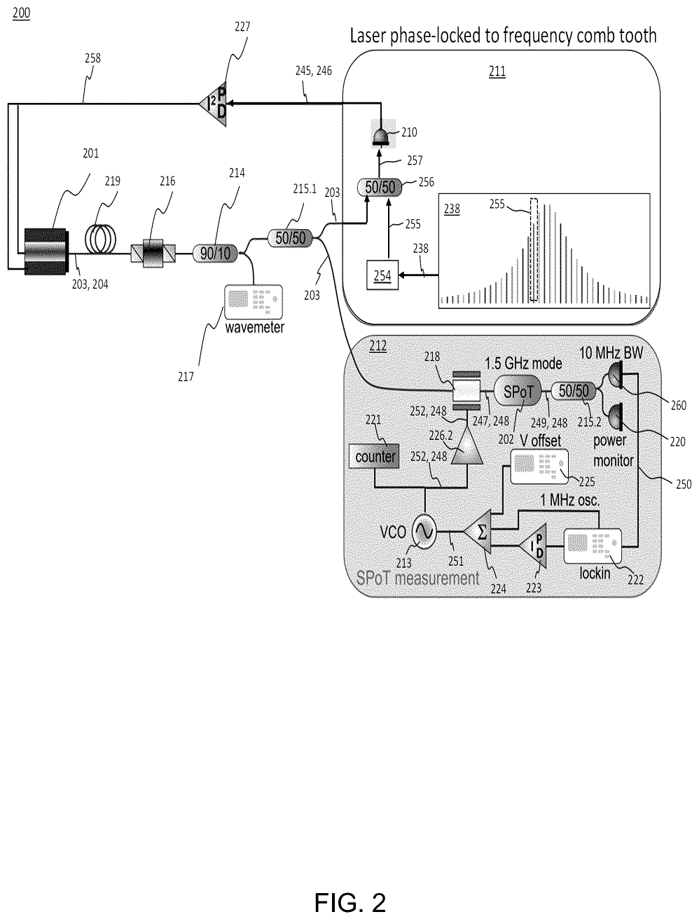

In an embodiment, with reference to FIG. 2, high precision photonic readout 200 includes laser stabilization module 211 that produces optical frequency comb 238 (e.g., an octave spanning self-reference phase stabilized fiber frequency comb). Optical frequency comb 238 is filtered by optical filter 254 that selects and transmits optical comb tooth 255 from optical frequency comb 238. Optical comb tooth 255 is combined with reference light 203 by fiber coupler 256 to make comb-reference combined light 257 that is received by photodetector 210 on which optical comb tooth 255 and reference light 203 in comb-reference combined light 257 beat against each other and that produces a difference frequency on photodetector 210 that produces a beat signal as laser stabilization signal 245 with reference frequency 246 that produces phase lock signal 258 by servo controller 227 to frequency stabilize laser source 201 to optical comb tooth 255 of optical frequency comb 238.

High precision photonic readout 200 can be made of various elements and components that can be assembled together or fabricated, can be various sizes and shapes, and can be made of a material that is physically or chemically resilient in an environment in which high precision photonic readout 200 is disposed. Exemplary materials include a metal, ceramic, thermoplastic, glass, semiconductor, and the like. The elements of high precision photonic readout 200 can be made of the same or different material and can be monolithic in a single physical body or can be separate members that are physically joined.

Laser source 201 can be any type of laser that produces a stabilized reference light 203. The laser is stabilized by feedback from laser stabilization module 211. The feedback ensures that the laser emits a beam of light with a constant frequency and amplitude. The laser can be equipped with a wavelength tuner that allows the wavelength of the laser to be adjusted.

Photonic sensor 202 is used to measure the intensity of reference light 203. Reference light 203 is used to stabilize the frequency of laser source 201. Photonic sensor 202 also measures the intensity of modulated light 205. Modulated light 205 is used to control the phase of laser source 201. It is contemplated that the photonic sensor can be a Fabry-Perot interferometer, and or whispering gallery mode photonic resonator. The laser can be a continuous wave laser. The modulator can be an electro-optic modulator. The detector can be a photodiode. The frequency counter can be a digital frequency counter. The controller can be a microcontroller. An exemplary photonic sensor 202 is that described as SPOT in U.S. Pat. No. 10,955,617, the disclosure of which is incorporated by reference in its entirety.

The photonic sensor can be configured to have a resonance frequency in telecom wavelength range from 1260 nm to 1610 nm. The laser can be configured to have a frequency of similar range. The modulator can be configured to phase-modulate the laser with a frequency of 1 MHz. The detector can be configured to detect light that is reflected from or transmitted through the photonic sensor. The frequency counter can be configured to measure the offset RF frequency of the light used to drive the EOM and frequency lock the photonic sensor. The controller can be configured to use the measured frequency to determine the temperature of the photonic sensor.

The photonic sensor can be placed in a temperature-controlled environment. The laser can be turned on, and the frequency counter can be started. The modulator can be turned on, and the frequency of the laser can be adjusted until the frequency counter measures a peak in the reflected or transmitted light from the photonic sensor. The temperature of the photonic sensor can be determined from the frequency of the laser.

Modulated light 205 is a light beam that is modulated in frequency by an electro-optic phase modulator 218. The modulation frequency is determined by reference light frequency 204, which is produced by laser source 201. Modulated light 205 is transmitted through optical reference cavity 209, which can be a Fabry-Perot cavity that can be tuned to a select resonance frequency. The light that is reflected back from the optical reference cavity is then received by photodetector 210. The signal from photodetector 210 is then used to produce reference stabilization signal 242, which is used to control the phase of the electro-optic phase modulator 261. This feedback loop ensures that reference light frequency 204 is stabilized. Modulation frequency 206 is the frequency at which the light from laser source 201 is modulated. It is used to create a reference signal that is used to stabilize the frequency of the laser. It can be varied to achieve different levels of stability.

Modulation control signal 207 is a signal that is used to control the modulation of the light emitted by laser source 201.

A fiber-to-free space coupler (FTSC) 208 couples light from an optical fiber to free space. Exemplary FTSCs include directional couplers and wavelength-division multiplexing (WDM) couplers. Directional couplers couple light from one fiber to another in a specific direction. WDM couplers couple light from multiple fibers to a single fiber, or vice versa. FTSCs can be made of two pieces of optical fiber that are fused together. The fibers are aligned so that the light waves from each fiber overlap. The overlap of the light waves causes them to interfere with each other, and this interference can be used to couple the light from one fiber to the other.

Optical reference cavity 209 is an optical element that stabilizes the frequency of laser source 201. Optical reference cavity 209 comprises a pair of mirrors 240 that are arranged, e.g., to form a Fabry-Perot cavity. The mirrors 240 can be made of high-reflectivity material, such as gold or silver.

Photodetector 210 is a semiconductor device that converts light into an electrical signal. It can be made of a semiconductor material such as silicon or germanium, and it has two terminals: a cathode and an anode. When light hits the photodetector, it creates an electric current that flows between the cathode and the anode. The amount of current that flows is proportional to the intensity of the light.

Laser stabilization module 211 stabilizes the frequency of laser source 201 and can include fiber coupler 256, optical filter 254, photodetector 210, and transmission photodetector 259. Optical filter 254 filters out the light that is not at the desired frequency. Photodetector 210 detects the light from fiber coupler 256 and produces a signal that corresponds to a beat frequency of light frequencies in comb-reference combined light 257.

Photonic sensor measurement module 212 produces light offset frequency 248 from reference light 203, which is then used to produce modulator control signal 252. Photonic sensor measurement module 212 can include: electro optic phase modulator 218 that modulates reference light 203; photonic sensor 202 that detects modulated light 205; and reference frequency source 213 that provides a reference frequency for photonic sensor 202. Photonic sensor measurement module 212 has a high sensitivity, which allows it to detect small changes in light offset frequency 248; has a high resolution, which allows it to accurately measure light offset frequency 248; has a wide bandwidth, which allows it to measure a wide range of light offset frequencies; and is stable such that maintains accuracy and resolution over time.

Reference frequency source 213 can be a variety of different types of devices, such as a voltage controlled oscillator, crystal oscillator, a rubidium atomic clock, or a cesium atomic clock.

Optical power splitter 214 and optical power splitter 215 are optical component that splits an optical signal into two or more output signals. It can be used to distribute light from a single source to multiple destinations, or to combine light from multiple sources into a single output signal. Optical power splitter 215 can be made of a material such as silicon or glass, and has two or more input ports and two or more output ports. The splitter can be used to distribute light evenly among multiple detectors, or to combine light from multiple sources into a single beam.

An optical isolator is a device that prevents light from traveling in the reverse direction through an optical system. This is important in many applications, such as laser stabilization, where it is necessary to prevent feedback from the laser into the laser cavity. Optical isolators can be made from a variety of materials, including Faraday rotators, semiconductor optical amplifiers, and polarization-dependent isolators. In high precision photonic readout 200, optical isolator 216 is used to prevent feedback to laser source 201 from optical reference cavity 209.

Wavelength meter 217 is a device that measures the wavelength of light and can include a laser source, a photodetector, and a wavelength discriminator. The laser source produces a beam of light with a known wavelength. The photodetector converts the light into an electrical signal. The wavelength discriminator compares the electrical signal to a reference signal and determines the wavelength of the light.

An electro-optic phase modulator (218, 261) (EOPM) modulates the phase of light by applying an electric field to a material that has a nonlinear optical property. This causes the refractive index of the material to change, which in turn changes the phase of the light passing through it. The properties of an EOPM depend on a number of factors, including the material it is made from, the applied electric field, and the wavelength of the light. The phase modulation depth, which is the maximum change in phase that can be achieved, can be in a selected range with a bandwidth in the range of frequencies over which the phase modulation that can be achieved.

RF frequency counter 221 is a device that measures the frequency of an RF signal. It does this by counting the number of cycles of the signal that occur in a given time interval. The frequency counter 221 can be used to measure the frequency of a wide variety of RF signals, including those used in communications, radar, and test and measurement applications. The frequency counter 221 can include a mixer, a discriminator, and a counter. The mixer converts the RF signal to a lower frequency signal that is easier to work with. The discriminator then converts the lower frequency signal to a digital signal that represents the frequency of the RF signal. The counter then counts the number of cycles of the digital signal that occur in a given time interval. The frequency counter 221 can be used to measure the frequency of an RF signal with a high degree of accuracy.

Lock-in amplifier 222 measures signals produced by photonic sensor 202. The reference signal is produced by reference frequency source 213 and is synchronized with the light from laser source 201.

Servo controller 227 is a feedback control system that stabilizes the frequency of laser source 201. It receives laser stabilization signal 245 from laser stabilization module 211 and produces phase lock signal 258 that controls the frequency of laser source 201. Servo controller 227 is designed to stabilize the frequency of laser source 201 to within a few parts per million.

An optical frequency comb is an optical signal with a large number of discrete frequency components. The frequency components are evenly spaced in frequency, and the spacing can be much smaller than the optical bandwidth of the comb. Optical frequency combs are generated by a variety of methods, including mode-locked lasers, nonlinear optical frequency conversion, and photonic crystal cavities.

Reflected reference light 241 is light reflected off of a mirror in optical reference cavity 209. The light is produced by laser source 201 and is modulated by electro optic phase modulator 218. The modulated light beam is then transmitted through optical reference cavity 209, where it is reflected off of the mirror 240. The reflected light is then received by photodetector 210.

Reference stabilization signal 242 is a signal that is used to stabilize the frequency of laser source 201. The signal is produced by laser stabilization module 211 and is communicated to servo controller 227. Servo controller 227 uses the signal to control the frequency of laser source 201.

Laser stabilization signal 245 is a signal that is produced by laser stabilization module 211 and communicated from laser stabilization module 211 to servo controller 227 for production of phase lock signal 258 that stabilizes reference light frequency 204 of reference light 203 produced by laser source 201.

Offset light 247 is produced by the electro-optic phase modulator 218. The phase modulator changes the phase of light. For example, the phase modulator can change the phase of reference light 203 by a specific amount to what create offset light 247. Offset light 247 can have a frequency that is equal to the frequency of reference light 203 plus the frequency of the modulation signal, wherein modulator control signal 252 with light offset frequency 248 controls the phase modulator. The frequency of the modulation signal can be changed to create different offset frequencies. Offset light 247 is used to produce sensor light 249. Light offset frequency 248 is the frequency of the light produced by electro optic phase modulator 218.

Sensor light 249 is produced by photonic sensor 202, wherein photonic sensor 202 is disposed in photonic sensor measurement module 212 and is in optical communication with laser source 201, electro optic phase modulator 218, and photodetector 210. Photonic sensor 202 receives offset light 247 with light offset frequency 248 from electro optic phase modulator 218, produces sensor light 249 with light offset frequency 248 from offset light 247, and communicates sensor light 249 to photodetector 210. Sensor light 249 is highly stable, monochromatic, highly coherent, and highly sensitive.

Photodetector signal 250 is produced by photodetector 260 in response to receipt of offset light 247. Photodetector signal 250 is a time-varying signal that has a frequency component at light offset frequency 248. The amplitude of photodetector signal 250 is proportional to the intensity of offset light 247. Photodetector signal 250 can be used to measure light offset frequency 248, the intensity of offset light 247, or both.

Modulator control signal 252 is produced by reference frequency source 213 and is communicated to RF frequency counter 221 and electro optic phase modulator 218. Electro optic phase modulator 218 uses the signal to modulate the phase of reference light 203 emitted by laser source 201.

Optical filter 254 passes light of a certain wavelength while blocking light of other wavelengths, wherein optical filter 254 selectively transmits a particular optical comb tooth 255 from the plurality of teeth in optical frequency comb 238. An optical comb tooth is a single frequency component of an optical frequency comb. Optical frequency combs are a type of optical spectrum with a regular, evenly spaced frequency distribution. They are generated by a nonlinear optical process in which a laser beam is amplified in a nonlinear medium. The nonlinear medium causes the laser beam to split into a series of discrete frequencies, which are the optical frequency comb teeth. The teeth are stable such that their frequencies do not drift over time, and the teeth precise such that their frequencies can be controlled to a very high degree. Optical comb tooth 255 is used to stabilize the frequency of laser source 201. The optical comb tooth can be generated by a nonlinear optical process in a nonlinear medium, such as a semiconductor optical amplifier (SOA). The optical comb tooth is then filtered by optical filter 254 to remove any unwanted frequencies. The filtered optical comb tooth is then combined with reference light 203 from laser source 201 to produce comb-reference combined light 257. Comb-reference combined light 257 is then detected by photodetector 210 to produce laser stabilization signal 245.

Phase lock signal 258 stabilizes the frequency 204 of reference light 203 produced by laser source 201. Phase lock signal 258 is produced by laser stabilization module 211 via servo controller 227, wherein laser stabilization module 211 receives reference light 203 from laser source 201. Servo controller 227 uses reference frequency 246, to produce phase lock signal 258 that adjusts reference light frequency 204 of reference light 203.

Transmission photodetector 259 is disposed in laser stabilization module 211 and in optical communication with optical reference cavity 209. It receives modulated light 205 transmitted through optical reference cavity 209. Photonic sensor photodetector 260 converting sensor light 249 from photonic sensor 202 into photodetector signal 250, an electrical signal, that is converted into modulator control signal 252 and processed by reference frequency source 213.

High precision photonic readout 200 can be made in various ways. It should be appreciated that high precision photonic readout 200 includes a number of optical, electrical, or mechanical components, wherein such components can be interconnected and placed in communication (e.g., optical communication, electrical communication, mechanical communication, fluid communication, and the like) by physical, chemical, optical, or free-space interconnects. The components can be disposed on mounts that can be disposed on a bulkhead for alignment or physical compartmentalization. As a result, high precision photonic readout 200 can be disposed in a terrestrial environment or space environment.

High precision photonic readout 200 has numerous advantageous and unexpected benefits and uses. In an embodiment, a process for performing high precision photon sensing includes: providing a photonic sensor 202 having a resonance frequency; providing reference light 203 having reference light frequency 204 that is offset from the resonance frequency of the photonic sensor 202; stabilizing reference light frequency 204 to optical reference cavity 209 via locking reference light frequency 204 to an optical mode of optical reference cavity 209; modulating reference light 203 with reference frequency 251 (from oscillator 231 applied by electro optic phase modulator 261) that is substantially equal to or greater than the resonance frequency 257 of the photonic sensor 202; modulating reference light 203 with a broadband EOM phase-modulator 218 with modulator control signal 252 (a phase-modulated drive signal); detecting the sensor light 249 that is reflected from or transmitted through photonic sensor 202; measuring light offset frequency 248 of sensor light 249; and using modulator control signal 252 to determine the temperature, strain, or other property of the photonic sensor 202.

In an embodiment, a process for high precision photonic readout includes: providing a photonic sensor having a resonance frequency; providing a laser having a frequency that is offset from the resonance frequency of the photonic sensor; modulating the laser with a frequency that is substantially equal to the resonance frequency of the photonic sensor; detecting microwave signal that drives the EOM to resonance with the photonic sensor; measuring the frequency of the offset frequency driving the EOM to the photonic sensor; and using the measured frequency to determine the temperature, strain, or other property of the photonic sensor. In an embodiment, the photonic sensor is a Fabry-Perot interferometer. In another embodiment, the photonic sensor is a whispering galley mode photonic resonator, such as ring, or disk resonator. In an embodiment, the laser is a continuous wave laser. In an embodiment, the modulator is an electro-optic modulator. In an embodiment, the detector is a photodiode. In an embodiment, the frequency counter is a digital frequency counter. In an embodiment, the laser frequency is adjusted to be a few GHz away from optical resonance of photonic sensor; in an embodiment 5 GHz away from the photonic sensor resonance.

In an embodiment, light from the laser is split using optical power splitter, into modulation control signal 207, and fiber-to-free space coupler 208. In an embodiment 50-50 optical power splitter, or the like, is used to split the light.

In an embodiment, reference light is going through laser stabilization module 211 in which the laser is locked to a stable optical reference cavity 209 by frequency locking, such as, for example, Pound-Drever-Hall (PDH) method. In an embodiment, the free spectral range of the cavity is 300 MHZ, and the cavity mode width is 0.8 MHZ. In an embodiment, in PDH locking, the reference light incident on the high-finesse cavity is phase-modulated. The error signal is promotional to the difference in frequency between the reference laser light and the cavity resonance. The PDH error signal for locking to cavity resonance can be generated by measuring intensity modulation reflected from optical reference cavity 209 using photodetector 210, and demodulating the output.

In an embodiment, fiber-to-free space coupler 208 communicates through the photonic sensor measurement module 212. In an embodiment, fiber-to-free space coupler 208 communicates through a broadband electro-optical (EOM) phase-modulator with a phase-modulated drive signal.

In an embodiment, a sideband samples a photonic sensor cavity using reference frequency source 213 (VCO). In an embodiment, reference frequency source 213 dithers one of the phase-modulated sidebands across the resonance of the SPOT sensor. In an embodiment, a triangular ramp is put on the VCO. In an embodiment, external voltage offset controls the center position of the VCO sweep.

In an embodiment, a sideband frequency is locked to the photonic sensor.

In an embodiment, a process for performing high precision photon sensing with high precision photonic readout 200 includes: providing a laser; providing a photonic sensor; splitting the laser into two lights, a modulation control signal 207 and fiber-to-free space coupler 208; directing the reference light to optical reference cavity 209; directing the measurement light to the photonic sensor; modulating the measurement light with a frequency that is offset from the resonance frequency of the photonic sensor; detecting the light that is reflected from the photonic sensor; demodulating the detected light to produce an error signal that is proportional to the difference in frequency between the measurement light and the photonic sensor cavity resonance; and using the signal to determine the resonance frequency of the photonic sensor.

In an embodiment, high precision photonic readout 200 includes: a laser, a photonic sensor, an optical high-finesse reference cavity, a modulator, a detector, and a demodulator. The laser is configured to emit a beam of light. The photonic sensor is configured to reflect or transmit light that is incident upon it. The optical reference cavity is configured to reflect light that is incident upon it. The modulator is configured to modulate the light that is emitted by the laser. The detector is configured to detect the light that is reflected from or transmitted through the photonic sensor. The demodulator is configured to demodulate the signal that is produced by the detector.

In an embodiment, a system for high precision photonic readout includes high precision photonic readout 200 and a controller. The controller is configured to control the operation of the apparatus.

In an embodiment, a process for performing high precision photon sensing includes: providing a laser source; providing a photonic sensor; coupling the laser source to the photonic sensor; modulating the laser source; detecting the light from the photonic sensor; and demodulating the detected light to obtain a signal indicative of the resonance frequency of the photonic sensor.

In another embodiment, high precision photonic readout 200 includes: a laser source; a photonic sensor; a modulator; a detector; and a demodulator.

The laser source is configured to emit light at a predetermined frequency. The photonic sensor is configured to have a resonance frequency that is responsive to a physical property of interest. The modulator is configured to modulate the light from the laser source. The detector is configured to detect the light from the photonic sensor. The demodulator is configured to demodulate the detected light to obtain a signal indicative of the resonance optical frequency of the photonic sensor.

The laser source 201 emits light at a predetermined frequency, such as 1550 nm. The photonic sensor 202 is configured to have a resonance frequency that is responsive to a physical property of interest, such as temperature. The reference light 203 is configured to modulate the light from the laser source 201. The reference light frequency 204 is configured to detect the light from the photonic sensor 202. The modulated light 205 is configured to demodulate the detected light to obtain a signal indicative of the resonance optical frequency of the photonic sensor 202.

The reference light 203 can be acousto-optic modulator, electro-optic modulator, or any other type of modulator that can be used to modulate light. The reference light frequency 204 can be a photodiode, avalanche photodiode, or any other type of detector that can be used to detect light. The modulated light 205 can be a lock-in amplifier, phase-locked loop, or any other type of demodulator that can be used to demodulate light.

The light from the laser source 201 is coupled to the photonic sensor 202 via a modulation frequency 206. The modulation frequency 206 can be a fiber optic coupler, a waveguide coupler, or any other type of coupler that can be used to couple light to the photonic sensor.

The light from the photonic sensor 202 is detected by the reference light frequency 204. The reference light frequency 204 converts the light into an electrical signal. The electrical signal is then demodulated by the modulated light 205 to obtain a signal indicative of the resonance optical frequency of the photonic sensor 202.

High precision photonic readout 200 compared with conventional devices has improved precision due to the high precision laser source and photonic sensor, increased stability for photon sensing, and reduced noise. The present invention can be used to achieve high precision measurements very quickly of the resonance frequency of a photonic sensor and is relatively robust and can be used in a variety of environments with ease of being multiplexed to measure many photonic sensors. The present invention provides a number of advantages over conventional methods and apparatus, wherein the present invention is not susceptible to noise and drift, which can lead to errors in the measurement of the resonance frequency of the sensor.

While one or more embodiments have been shown and described, modifications and substitutions can be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It can also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

### PARTS LIST

high precision photonic readout 200
laser source 201
photonic sensor 202
reference light 203
reference light frequency 204
modulated light 205
modulation frequency 206
modulation control signal 207
fiber-to-free space coupler 208
optical reference cavity 209
photodetector 210
laser stabilization module 211
photonic sensor measurement module 212
reference frequency source 213
optical power splitter 214
optical power splitter 215
optical isolator 216
wavelength meter 217
electro optic phase modulator 218
electro optic phase modulator 261
optical fiber 219
optical power meter 220
RF frequency counter 221
lock-in amplifier 222
servo controller 223
summing amplifier 224
DC voltage source 225
RF amplifier 226
servo controller 227
RF mixer 228
RF filter 229
oscilloscope 230
oscillator 231
planar optical mirror 233
polarizing beam splitter 234
polarizer 235
lens 236
optical frequency comb 238
cavity mirror 240
reflected reference light 241
reference stabilization signal 242
bias tee 243
optical stabilization radio frequency component 244
laser stabilization signal 245
reference frequency 246
offset light 247
light offset frequency 248
sensor light 249
photodetector signal 250
frequency lock signal 251
modulator control signal 252
optical filter 254
optical comb tooth 255
fiber coupler 256
comb-reference combined light 257
phase lock signal 258
transmission photodetector 259
photonic sensor photodetector 260
performing high precision photon sensing/performs high precision photon sensing

What is claimed is:

1. A high precision photonic readout 200 for performing high precision photon sensing, the high precision photonic readout 200 comprising:
laser source 201 in electrical communication with laser stabilization module 211 and in optical communication with photonic sensor measurement module 212 and that receives phase lock signal 258 from laser stabilization module 211, produces reference light 203 with reference light frequency 204, communicates reference light 203 to laser stabilization module 211 and photonic sensor measurement module 212, such that reference light 203 comprises reference light frequency 204, is produced by laser source 201, is received by laser stabilization module 211 for production of phase lock signal 258, and is received by photonic sensor measurement module 212 for production of modulator control signal 252; and such that reference light frequency 204 produced by laser source 201 is stabilized by phase lock signal 258 from laser stabilization module 211;
photonic sensor 202 disposed in photonic sensor measurement module 212 and in optical communication with laser source 201, electro optic phase modulator 218 and photonic sensor photodetector 260 and that receives offset light 247 with light offset frequency 248 from electro optic phase modulator 218, produces sensor light 249 with light offset frequency 248 from offset light 247, communicates sensor light 249 to photodetector 210;
laser stabilization module 211 in optical communication with laser source 201 and that receives reference light 203 from laser source 201, and produces phase lock signal 258 that stabilizes reference light frequency 204 of reference light 203 from laser source 201;
photonic sensor measurement module 212 in optical communication with laser source 201 and that receives reference light 203 from laser source 201, produces light offset frequency 248 from reference light 203 as a high precision photonic readout, and comprises electro optic phase modulator 218, photonic sensor 202, and photonic sensor photodetector 260;
laser stabilization signal 245 that is produced by laser stabilization signal 245 and communicated from laser stabilization module 211 to servo controller 227 for production of phase lock signal 258 that stabilizes reference light frequency 204 of reference light 203 produced by laser source 201;
reference frequency 246 that is produced by RF mixer 228 of laser stabilization module 211 and is frequency of laser stabilization signal 245;
modulator control signal 252 that is produced by reference frequency source 213 from frequency lock signal 251 and communicated by reference frequency source 213 to RF frequency counter 221 and electro optic phase modulator 218 for production of offset light 247 from reference light 203; and
photonic sensor photodetector 260 disposed in photonic sensor measurement module 212 and in optical communication with photonic sensor 202 and in electrical communication with reference frequency source 213 and that receives sensor light 249 from photonic sensor 202, produces photodetector signal 250 from offset light 247, communicates photodetector signal 250 to reference frequency source 213 for production of modulator control signal 252.

2. The high precision photonic readout 200 of claim 1, further comprising:
modulated light 205 produced by electro optic phase modulator 218 of laser stabilization module 211 in response to receipt of reference light 203 from laser source 201 and modulation frequency 206 from oscillator 231;
modulation frequency 206 produced by oscillator 231 of laser stabilization module 211 in response to receipt of 277 from RF mixer 228 of laser stabilization module 211, received by electro optic phase modulator 218 of laser stabilization module 211 for modulation of reference light 203 in production of modulated light 205 with modulation frequency 206;
modulation control signal 207 produced by RF mixer 228 of laser stabilization module 211 in response to receipt of reference stabilization signal 242 from photodetector 210 and received by oscillator 231 of laser stabilization module 211 for production of modulation frequency 206;
optical reference cavity 209 in optical communication with electro optic phase modulator 218 and photodetector 210 and that receives modulated light 205 with modulation frequency 206 from electro optic phase modulator 218 of laser stabilization module 211, produces reflected reference light 241 with optical stabilization radio frequency component 244 from modulated light 205, and comprises a pair of opposing cavity mirror 240;
photodetector 210 disposed in laser stabilization module 211 and in optical communication with optical reference cavity 209 and in electrical communication with servo controller 227 and that receives reflected reference light 241 with optical stabilization radio frequency component 244 from optical reference cavity 209, produces reference stabilization signal 242 with optical stabilization radio frequency component 244 from reflected reference light 241, and communicates reference stabilization signal 242 toward servo controller 227 for production of phase lock signal 258 by servo controller 227;
electro optic phase modulator 261 disposed in laser stabilization module 211 and in optical communication with laser source 201 and in electrical communication with oscillator 231 and in optical communication with optical reference cavity 209 and that receives reference light 203 from laser source 201, receives modulation frequency 206 from oscillator 231, produces modulated light 205 with modulation frequency 206 by modulating reference light 203 with modulation frequency 206, and communicates modulated light 205 to optical reference cavity 209 for production of reflected reference light 241 with by optical reference cavity 209;
servo controller 227 in electrical communication with laser stabilization module 211 and laser source 201 and that receives laser stabilization signal 245 with reference frequency 246 from laser stabilization module 211, produces RF mixer 228 from laser stabilization signal 245, and communicates phase lock signal 258 to laser source 201 for stabilization of reference light frequency 204 of reference light 203;
reflected reference light 241 that comprises optical stabilization radio frequency component 244, is produced by optical reference cavity 209 from modulated light 205 and is received by photodetector 210 for production of reference stabilization signal 242;
reference stabilization signal 242 that comprises optical stabilization radio frequency component 244, is produced by photodetector 210 from reflected reference light 241 and is received by RF filter 229 for production of laser stabilization signal 245 with reference frequency 246 by RF mixer 228;
offset light 247 that is produced by electro optic phase modulator 218 in photonic sensor measurement module 212 from reference light 203;
light offset frequency 248 that is produced by electro optic phase modulator 218 in photonic sensor measurement module 212 by modulation of reference light 203 driven by modulator control signal 252;
sensor light 249 that is produced by photonic sensor 202 in photonic sensor measurement module 212 by interaction with offset light 247 from electro optic phase modulator 218; and
phase lock signal 258 that produced by servo controller 227 from laser stabilization signal 245 produced by laser stabilization module 211 and received by laser source 201 for stabilization of reference light frequency 204 of reference light 203 produced by laser source 201.

3. The high precision photonic readout 200 of claim 1, further comprising:
electro optic phase modulator 218 disposed in photonic sensor measurement module 212 and in optical communication with laser source 201 and photonic sensor 202 and in electrical communication with reference frequency source 213 and that receives reference light 203 from laser source 201, receives modulator control signal 252 with light offset frequency 248 from reference frequency source 213, produces offset light 247 with light offset frequency 248 by modulating reference light 203 with modulator control signal 252, and communicates offset light 247 to photonic sensor 202 for production of modulator control signal 252 by photonic sensor measurement module 212; and
RF frequency counter 221 disposed in photonic sensor measurement module 212 and in electrical communication with reference frequency source 213 and that receives modulator control signal 252 with light offset frequency 248 from reference frequency source 213 in response to reference frequency source 213 receiving frequency lock signal 251 and determines light offset frequency 248.

4. The high precision photonic readout 200 of claim 2, further comprising fiber-to-free space coupler 208 in optical communication with electro optic phase modulator 218 and optical reference cavity 209 and that receives modulated light 205 with modulation frequency 206 from electro optic phase modulator 218 of laser stabilization module 211 and communicates modulated light 205 to optical reference cavity 209 for production of reflected reference light 241 by optical reference cavity 209.

5. The high precision photonic readout 200 of claim 1, further comprising reference frequency source 213 disposed in photonic sensor measurement module 212 and in electrical communication with electro optic phase modulator 218 and photonic sensor photodetector 260 and that receives frequency lock signal 251 as a result of production of photodetector signal 250 by photonic sensor photodetector 260 of photonic sensor measurement module 212, produces modulator control signal 252 with light offset frequency 248 from frequency lock signal 251, and communicates modulator control signal 252 to electro optic phase modulator 218 of photonic sensor measurement module 212 for production of offset light 247 from reference light 203.

6. The high precision photonic readout 200 of claim 1, further comprising optical power splitter 214 in optical communication with laser source 201, laser stabilization module 211, wavelength meter 217 and that receives reference light 203 from laser source 201, optically splits reference light 203, and communicates reference light 203 to laser stabilization module 211 and photonic sensor measurement module 212;
optical power splitter 215 in optical communication with laser source 201, laser stabilization module 211, and photonic sensor measurement module 212 and that receives reference light 203 from laser source 201, optically splits reference light 203, and communicates reference light 203 to laser stabilization module 211 and photonic sensor measurement module 212; and
optical isolator 216 in optical communication with laser source 201, laser stabilization module 211, and photonic sensor measurement module 212 and that receives reference light 203 from laser source 201, communicates reference light 203 to laser stabilization module 211 and photonic sensor measurement module 212, and optically isolates light from laser stabilization module 211 and photonic sensor measurement module 212 from transmission to laser source 201.

7. The high precision photonic readout 200 of claim 1, further comprising optical fiber 219 in optical communication with laser source 201, laser stabilization module 211, and photonic sensor measurement module 212 and that receives reference light 203 from laser source 201 and communicates reference light 203 to laser stabilization module 211 and photonic sensor measurement module 212.

8. The high precision photonic readout 200 of claim 1, further comprising:
wavelength meter 217 in optical communication with laser source 201 and that receives reference light 203 from laser source 201 and determines an optical wavelength of reference light 203; and
optical power meter 220 disposed in photonic sensor measurement module 212 and in optical communication with photonic sensor 202 and that receives sensor light 249 with light offset frequency 248 from photonic sensor 202 in response to photonic sensor 202 receiving offset light 247 with light offset frequency 248 from electro optic phase modulator 218 and determines an optical power of sensor light 249.

9. The high precision photonic readout 200 of claim 3, further comprising lock-in amplifier 222 disposed in photonic sensor measurement module 212 and in electrical communication with photonic sensor photodetector 260 and reference frequency source 213 and that receives photodetector signal 250 from photonic sensor photodetector 260 and provides frequency lock signal 251 to reference frequency source 213 for production of modulator control signal 252.

10. The high precision photonic readout 200 of claim 9, further comprising:
servo controller 223 disposed in photonic sensor measurement module 212 and in electrical communication with lock-in amplifier 222 and reference frequency source 213 and that receives output from lock-in amplifier 222 and sends frequency lock signal 251 to reference frequency source 213 from which modulator control signal 252 is produced;
summing amplifier 224 disposed in photonic sensor measurement module 212 and in electrical communication with servo controller 223, DC voltage source 225, lock-in amplifier 222. and in electrical communication with reference frequency source 213 and that receives output from servo controller 223, lock-in amplifier 222, DC voltage source 225, produces frequency lock signal 251 from outputs of servo controller 223, lock-in amplifier 222, and DC voltage source 225, and communicates frequency lock signal 251 to reference frequency source 213 for production of modulator control signal 252;
DC voltage source 225 disposed in photonic sensor measurement module 212 and in electrical communication with summing amplifier 224 and that produces a DC voltage that summing amplifier 224 sums with outputs from lock-in amplifier 222 and servo controller 223 in production of frequency lock signal 251; and
frequency lock signal 251 that is produced from photodetector signal 250 by lock-in amplifier 222 and received by reference frequency source 213 for production of modulator control signal 252.

11. The high precision photonic readout 200 of claim 2, further comprising:
RF mixer 228 disposed in laser stabilization module 211 and in electrical communication with photodetector 210 and servo controller 227 and that receives reference stabilization signal 242 from photodetector 210, produces laser stabilization signal 245 with reference frequency 246 from reference stabilization signal 242, and communicates laser stabilization signal 245 to servo controller 227;
RF filter 229 disposed in laser stabilization module 211 and in electrical communication with RF mixer 228 and photodetector 210 and that receives reference stabilization signal 242 from photodetector 210, filters the RF component of reference stabilization signal 242, and communicates the RF component to RF mixer 228; and
optical stabilization radio frequency component 244 that is produced by photodetector 210 from receipt of reflected reference light 241 from optical reference cavity 209 and received by RF filter 229 for production of laser stabilization signal 245 by RF mixer 228.

12. The high precision photonic readout 200 of claim 2, further comprising oscilloscope 230 disposed in laser stabilization module 211 and in electrical communication with photodetector 210 and that receives reference stabilization signal 242 from photodetector 210 and processes reference stabilization signal 242.

13. The high precision photonic readout 200 of claim 2, further comprising oscillator 231 disposed in laser stabilization module 211 and in electrical communication with photodetector 210 and electro optic phase modulator 218 and that receives modulation control signal 207 from RF mixer 228, produces modulation frequency 206 from modulation frequency 206, and communicates reference light 203 to electro optic phase modulator 218 for modulation of reference light 203.

14. The high precision photonic readout 200 of claim 2, further comprising planar optical mirror 233 disposed in laser stabilization module 211 and in optical communication with electro optic phase modulator 218 and optical reference cavity 209 and that receives modulated light 205 from electro optic phase modulator 218, directs propagation of modulated light 205 in laser stabilization module 211, and communicates modulated light 205 to optical reference cavity 209.

15. The high precision photonic readout 200 of claim 2, further comprising:
polarizing beam splitter 234 disposed in laser stabilization module 211 and in optical communication with electro optic phase modulator 218 and optical reference cavity 209 and that receives modulated light 205 from electro optic phase modulator 218, communicates modulated light 205 from electro optic phase modulator 218 to optical reference cavity 209, receives reflected reference light 241 from optical reference cavity 209, and communicates reflected reference light 241 from optical reference cavity 209 to photodetector 210;
polarizer 235 disposed in laser stabilization module 211 and in optical communication with polarizing beam splitter 234 and optical reference cavity 209 and that receives modulated light 205 from polarizing beam splitter 234, communicates modulated light 205 from polarizing beam splitter 234 to optical reference cavity 209, receives reflected reference light 241 from optical reference cavity 209, and communicates reflected reference light 241 from optical reference cavity 209 to polarizing beam splitter 234; and
lens 236 disposed in laser stabilization module 211 and in optical communication with polarizing beam splitter 234 and optical reference cavity 209 and that receives modulated light 205 from polarizing beam splitter 234, communicates modulated light 205 from polarizing beam splitter 234 to optical reference cavity 209, receives reflected reference light 241 from optical reference cavity 209, and communicates reflected reference light 241 from optical reference cavity 209 to polarizing beam splitter 234.

16. The high precision photonic readout 200 of claim 2, further comprising optical frequency comb 238 that comprises a plurality of optical comb tooth 255, is produced by laser stabilization module 211 and is received by optical filter 254 in laser stabilization module 211.

17. The high precision photonic readout 200 of claim 2, further comprising cavity mirror 240 disposed in laser stabilization module 211 and in optical communication with electro optic phase modulator 218 and photodetector 210 and that comprises a cavity mode with a resonance at optical stabilization radio frequency component 244, receives modulated light 205 from electro optic phase modulator 218, produces reflected reference light 241 with optical stabilization radio frequency component 244 from modulated light 205, and communicates reflected reference light 241 to photodetector 210.

18. The high precision photonic readout 200 of claim 2, further comprising bias tee 243 disposed in laser stabilization module 211 and in electrical communication with photodetector 210, oscilloscope 230, and RF mixer 228 and that receives reference stabilization signal 242 from photodetector 210, and communicates reference stabilization signal 242 to oscilloscope 230 and RF filter 229 for production of laser stabilization signal 245 by RF mixer 228.

19. The high precision photonic readout 200 of claim 1, further comprising photodetector signal 250 that is produced by photonic sensor photodetector 260 from sensor light 249 and received by lock-in amplifier 222 for production of modulator control signal 252 in photonic sensor measurement module 212.

20. The high precision photonic readout 200 of claim 1, further comprising:
optical filter 254 disposed in laser stabilization module 211 and in electrical communication with fiber coupler 256 and that receives optical frequency comb 238, selects optical comb tooth 255 from optical comb tooth 255, and communicates optical comb tooth 255 to fiber coupler 256 for combination with reference light 203;
optical comb tooth 255 that is an optical component of optical frequency comb 238 that is optically selected by optical filter 254 and combined with reference light 203 to produce comb-reference combined light 257 from which laser stabilization signal 245 is produced; and
comb-reference combined light 257 that is produced by fiber coupler 256 from combining reference light 203 and optical comb tooth 255.

21. The high precision photonic readout 200 of claim 20, further comprising:
fiber coupler 256 disposed in laser stabilization module 211 and in optical communication with laser source 201 and optical filter 254 and that receives optical comb tooth 255 from optical filter 254, receives reference light 203 from laser source 201, produces comb-reference combined light 257 from optically combining reference light 203 and optical comb tooth 255, and communicates comb-reference combined light 257 to photodetector 210 for production of laser stabilization signal 245; and
transmission photodetector 259 disposed in laser stabilization module 211 and in optical communication with optical reference cavity 209 and that receives modulated light 205 transmitted through optical reference cavity 209.

22. A process for performing high precision photon sensing with a high precision photonic readout 200, the process comprising: providing a photonic sensor 202 comprising a resonance frequency; providing reference light 203 comprising reference light frequency 204 that is offset from the resonance frequency of the photonic sensor 202; stabilizing reference light frequency 204 to optical reference cavity 209 via locking reference light frequency 204 to an optical mode of optical reference cavity 209; modulating reference light 203 with reference frequency 251 that is substantially equal to or greater than the resonance frequency 257 of the photonic sensor 202; modulating reference light 203 with a broadband EOM phase-modulator 218 with modulator control signal 252; detecting the sensor light 249 that is reflected from or transmitted through photonic sensor 202; measuring light offset frequency 248 of sensor light 249; and determining the temperature, or strain of the photonic sensor 202 from the modulator control signal 252.
